(19) United States
(12) Patent Application Publication
(10) Pub. No.: US 2017/0106823 A1
(43) Pub. Date: Apr. 20, 2017

(54) BUMPER DEVICE AND MOTOR VEHICLE

(71) Applicant: GM GLOBAL TECHNOLOGY OPERATIONS LLC, Detroit, MI (US)

(72) Inventors: Wolfram LIEVEN, Kleinostheim (DE); Michael WEIL, Rockenberg (DE)

(73) Assignee: GM GLOBAL TECHNOLOGY OPERATIONS LLC, Detroit, MI (US)

(21) Appl. No.: 14/882,684

(22) Filed: Oct. 14, 2015

(51) Int. Cl. B60R 19/34

(52) U.S. Cl. CPC B60R 19/34; B60R 2019/247

(57) ABSTRACT

A bumper device for a motor vehicle is described. A cross member assembly includes a cross member running transverse to a traveling direction and a side element extending from an end of the cross member. A side member assembly has a first end configured to be fixed to a vehicle structure and a second end fixed to the cross member. A support member extends from the side member assembly towards an end of the side element opposite the cross member. The support member is configured to absorb and transfer an oblique load acting on the side element to the side member assembly, and to defect without substantial resistance to the longitudinal load acting on the cross member in the traveling direction.

### TECHNICAL FIELD

The present disclosure pertains to a bumper device for a motor vehicle, as well as to a motor vehicle with such a bumper device.

### BACKGROUND

Bumper devices for motor vehicles are used to absorb loads that act on the front of a vehicle in the traveling direction or opposite the traveling direction, and transfer the load to the vehicle body. In order to absorb loads acting on the motor vehicle obliquely or transversely relative to the traveling direction, lateral elements that run parallel or obliquely relative to the traveling direction can be arranged on the cross members running transverse to the traveling direction in known bumper devices.

US 2004/0195862 A1 discloses a bumper device, in which a side member assembly with a side member is fixed on the side elements of the cross member assembly, and connected with a cross member of the cross member assembly by means of a support member extending in the traveling direction. The support member extending parallel to the traveling direction is here designed in such a way that it can be deformed in the event of a front-end collision.

In the known bumper device, it has proven disadvantageous that, given strong loads acting on the cross member of the cross member assembly in the traveling direction or opposite the traveling direction, the support member and side member assembly can impede each another's deformation, which reduces a force absorption effect of the bumper device.

### SUMMARY

In accordance with an embodiment of the present disclosure a bumper device is provided that improves the absorption of loads acting in the traveling direction, opposite the traveling direction as well as transversely or obliquely to the traveling direction. In particular, a bumper device for a motor vehicle includes at least one cross member assembly, which can be or is arranged on an end of the vehicle (i.e., the front end or rear end). The cross member assembly includes at least one cross member running transverse to the traveling direction, and at least one side element that continues the cross member transversely or obliquely to the traveling direction. At least one side member assembly is arranged essentially parallel to the traveling direction and fixed to a vehicle structure. The cross member of the cross member assembly can be or is fixed to the side member, such that an extension in the traveling direction can be reduced when a specific load acting on the side member assembly opposite the traveling direction has been exceeded. At least one support member extends from the side member assembly up to an end of the at least one side element opposite an end of the cross member, such that loads acting on the side element can be absorbed and transferred to the side member assembly, and which can be deflected nearly without substantial resistance when a specific load acting on the cross member opposite the traveling direction has been exceeded. The specific load includes loads that are larger than expected during the normal operation of a motor vehicle.

Because the side member assembly extends in the traveling direction and is arranged on the cross member, and because the side member assembly evades nearly without substantial resistance when the specific load is exceeded in terms of its extension, the absorption behavior of the bumper device is not impeded by the support member given loads acting against the traveling direction. The ability of the support member to transfer loads acting parallel or obliquely to the traveling direction, i.e., loads acting on the side element of the cross member assembly, improves the usability of the bumper device.

Because the side member assembly extends essentially parallel to the traveling direction and is arranged on the cross member, and because the support member is arranged from the side member assembly to the side element situated laterally on the cross member, the side member assembly, support member and side element form a triangular configuration. The support member can conceivably be fixed to both the side element and the side member assembly. However, an embodiment of the bumper device provides that the support member and side member assembly be spaced apart without contacting each other in a non-deformed basic position. In such a case, when a specific load acting on the side element is exceeded, only the side element is initially deformed before an absorption of the load by the support element takes place.

To ensure a coupling of the support member and side member assembly, one embodiment of the bumper device provides at least one receptacle, which includes at least one guide section that guides the movement of the support member from a non-deformed basic position to a load-absorbing position, and at least one stop that limits the movement of the support member.

In a further development of the latter embodiment, it proves advantageous for the guide section to include a surface of the side member assembly facing the support member and/or a recess in the side member assembly that in particular corresponds to and/or complements the contour of the support member, and/or a rail-like guide element that can be or is be fixed to the side member assembly. If the guide section includes a surface of the side member assembly that faces the support member, this surface can include a grooved recess, for example, into which the support member can engage, and be guided in its movement. In addition, the guide section can be easily and cost-effectively manufactured if the guide section includes a recess in the side member assembly that corresponds to and/or is complementary to the contour of the support member. In such a case, for example, the recess can be introduced by embossing or stamping the side member assembly. In addition, the receptacle can be fabricated without altering the side member assemblies if the guide section includes a rail-like guide element that can be or is fixed on the side member assembly.

It further proves advantageous for the stop to include a forming area and/or a floor element of the recess and/or a hook-shaped stop element that can be or is fixed on the side number assembly. If the stop includes a forming area that forms the recess, this forming area can be directed toward the vehicle center or protrude outwardly. If the stop includes a floor element of the recess, it can be formed during an embossing process, for example. The stop can be manufactured without any change to existing side member assemblies if it includes a hook-shaped stop element that can be or is fixed on the side member assembly. In such a case, the stop can be easily and cost-effectively retrofitted on existing side member assemblies.

To reduce the risk of movement by the support member, it proves advantageous for the bumper device to include at least one retaining means, which in the non-deformed basic position can be or is fixed to the side member assembly and to the support member, bridging a gap arranged between the side member assembly and support member. The retaining means can be provided at low cost if it includes a bent metal part and/or an L- or Z-shaped cross section. The retaining means can advantageously be bonded, soldered, welded and/or screwed to the side member assembly and/or to the support member.

The extension in the traveling direction when a specific load of the side member assembly is acting on the side member assembly in the traveling direction can be easily and cost-effectively ensured in particular if the side member assembly includes a side member and a deformation section arranged between the side member and cross member.

In an embodiment of the bumper device, the deformation section can be easily and cost-effectively ensured if the deformation section includes a shape- and/or material-weakening area of the side member and/or if the deformation section includes a deformation means that can be attached to the side member and continues the side member in the traveling direction.

In addition, it has proven advantageous if the support member is rigid in its direction of extension and/or includes a section that can be reduced in terms of its extension and/or if the support member can be deformed obliquely or transversely to its direction of extension and/or includes a predetermined breaking point for severing the connection between the side element and side number assembly.

In a further development of the last-mentioned embodiment, the section that is reducible in terms of the extension of the support member can include at least one shape- and/or material-weakening area and/or at least one recess.

It is basically conceivable that the side element continue the cross member and be situated so as to run transverse to the traveling direction. It is further conceivable for the cross member and side element to include a shared component. An embodiment of the bumper device provides that the at least one side element run obliquely or parallel to the traveling direction and/or that the cross member and side element include components that are separate or separable from each other.

Because the side element runs obliquely or parallel o the traveling direction, loads acting on the motor vehicle obliquely or transversely to the traveling direction can be absorbed and introduced into the body. Because the at least one side element includes a component that is separate or separable from the cross member, conventional motor vehicles can be easily and cost-effectively expanded by arranging a side element on a conventional cross member.

It is basically conceivable for only one side element to be arranged on the cross member assembly. An embodiment of the bumper device further provides that the cross member assembly include at least two side elements, wherein a respective side element is situated at a respective end of the cross member that is arranged transverse to the traveling direction.

The bumper device can be arranged at a vehicle front or vehicle rear. Likewise, a motor vehicle with a bumper device, in particular with one of the aforementioned features.

The bumper device and motor vehicle are advantageous in that the support member and side member assembly do not impede each other because the support member can be deflected without substantial resistance given a load acting opposite the traveling direction. In particular, the bumper device includes a side member assembly, which is extended in a traveling direction and can be reduced in terms of its extension given a load acting in a traveling direction, and includes a support member, with which loads acting transversely or obliquely on a side element of the bumper device can be introduced without substantial resistance.

Additional features, details and advantages may be gleaned from the attached claims, the graphic illustrations and the following description of a preferred embodiment of the bumper device.

### BRIEF DESCRIPTION OF THE DRAWINGS

The present invention will hereinafter be described in conjunction with the following drawing figures, wherein like numerals denote like elements.

FIG. 1 is a perspective side view of an exemplary embodiment of the bumper device;

FIG. 2 is a top view of the exemplary embodiment of the bumper device according to FIG. 1 in a deformed arrangement;

FIG. 3 is a detailed top view of the exemplary embodiment of the bumper device according to FIG. 1;

FIG. 4a is a detailed view of the bumper device according to FIG. 1 with a specific load acting on a side element; and

FIG. 4b is a detailed view according to FIG. 4a during a more prolonged exposure to the specific load.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The figures show a bumper device 2 for a motor vehicle which includes a cross member assembly 4 having a cross member 8 running transverse to a traveling direction indicated at arrow 6 along with side element 10 that extend obliquely to the traveling direction 6 and continue the cross member 8. The cross member assembly 4 is fixed by its cross member 8 on a side member assembly 12, which for its part is fixed to a vehicle structure.

The side member assembly 12 can be reduced in terms of its extension in the traveling direction 6 given a specific load acting on the side member assembly 12 opposite the traveling direction 6. In addition, the bumper device 2 includes at least one support member 14, which extends between the side member assembly 12 and an end of the side element 10 facing away from the cross member 8. The support member 14 can be used to absorb loads acting on the side element 10 and transfer them to the side member assembly 12. If a load acting on the cross member 8 of the cross member assembly 4 in the traveling direction 6 is exceeded, the support member 14 can be deflected without substantial resistance. In other words, the support member 14 provides essentially no energy dissipation to the specific load acting on the side member assembly 12 opposite the traveling direction 6.

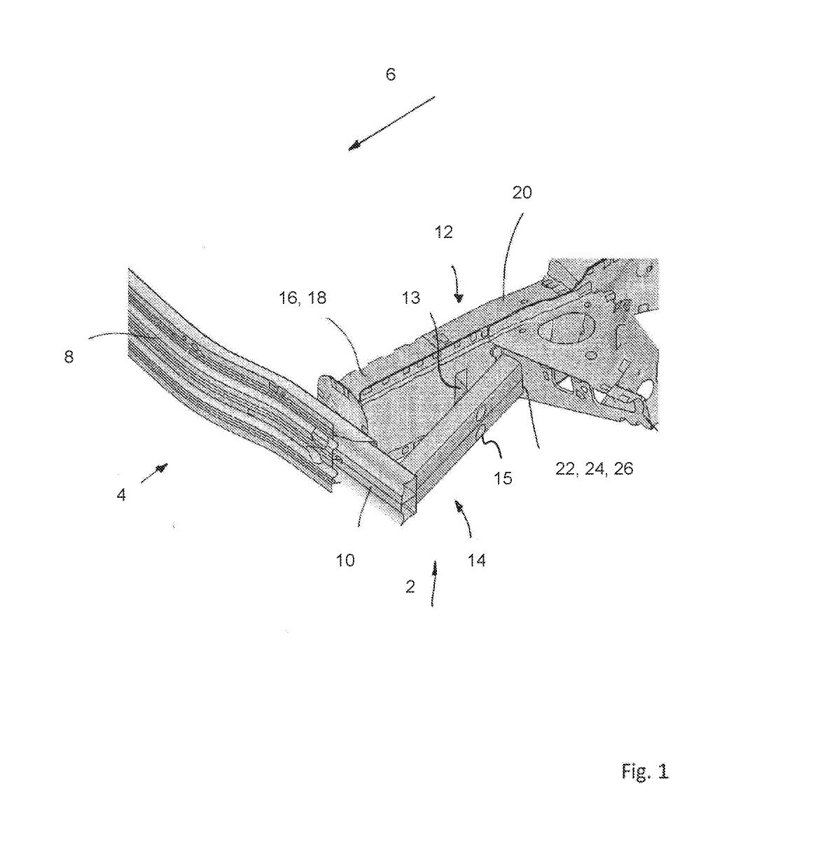

In the exemplary embodiment shown on FIG. 1, the support member 14 and side member assembly 12 are configured in such a way as to be spaced apart without contacting each other in a non-deformed basic position. Conversely, the support member 14 and the end of the side element 10 may be configured in such a way as to be spaced apart without contacting each other in a non-deformed basic position. The side member assembly 12, support member 14 and side element 10 are triangularly arranged relative to each other. In order to fix the support member 14 against inadvertently moving, a retaining bracket 13 is fixed on the side member assembly 12 and on the support member 14, such that the retaining bracket 13 bridges the gap formed there between.

To ensure that the side member assembly 12 deforms in the event of a load acting on the motor vehicle opposite the traveling direction 6, a deformation section 16, for example a crash box, is provided, which as shown in FIG. 1 includes crush initiators in the form of locally (e.g., shape and/or material) weakened regions 18. Behind the deformation section 16 is a side member 20 of the side member assembly 12, with which the side member assembly 12 can be fixed on the vehicle structure, In order to transfer the load acting on the support member 14 to the side member assembly 12, the side member 20 of the side member assembly 12 are provided with a receptacle 22. The receptacle 22 includes a guide section 24 and a stop 26. A movement by the support member 14 can be guided through the guide section 24 and limited by the stop 26, so as to transfer the load acting on the side element 10 to the side member assembly 12. The guide section 24 may include a surface of the side member assembly 12 facing the support member 14, a recess in the side member assembly 12 complementing a contour of the support member 14, or a rail-like guide element fixed to the side member assembly 12. The stop 26 may include a formed area on the side member assembly that defines a recess therein, or a hook-shaped stop element that fixed to the side member assembly.

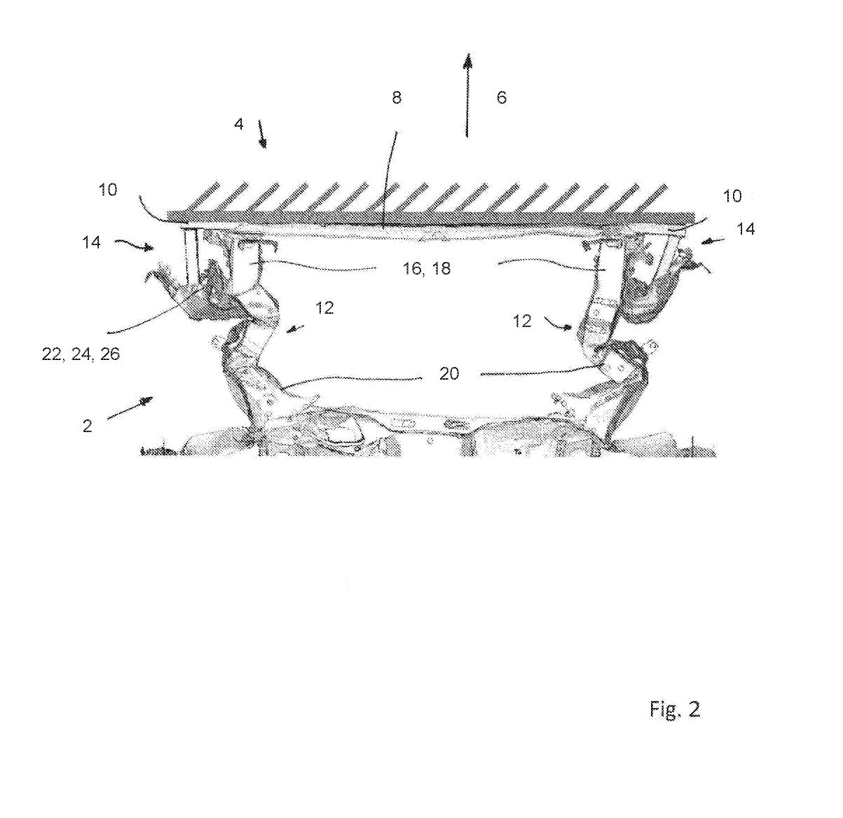

FIG. 2 shows a top view of the bumper device 2 in a deformed configuration. As further evident from this top view, a respective side element 10 is laterally arranged on the cross member 8 transverse to the traveling direction 6. In addition, two side member assemblies 12 and two support assemblies 14 are each laterally situated with respect to the cross member 8 of the cross member assembly 4.

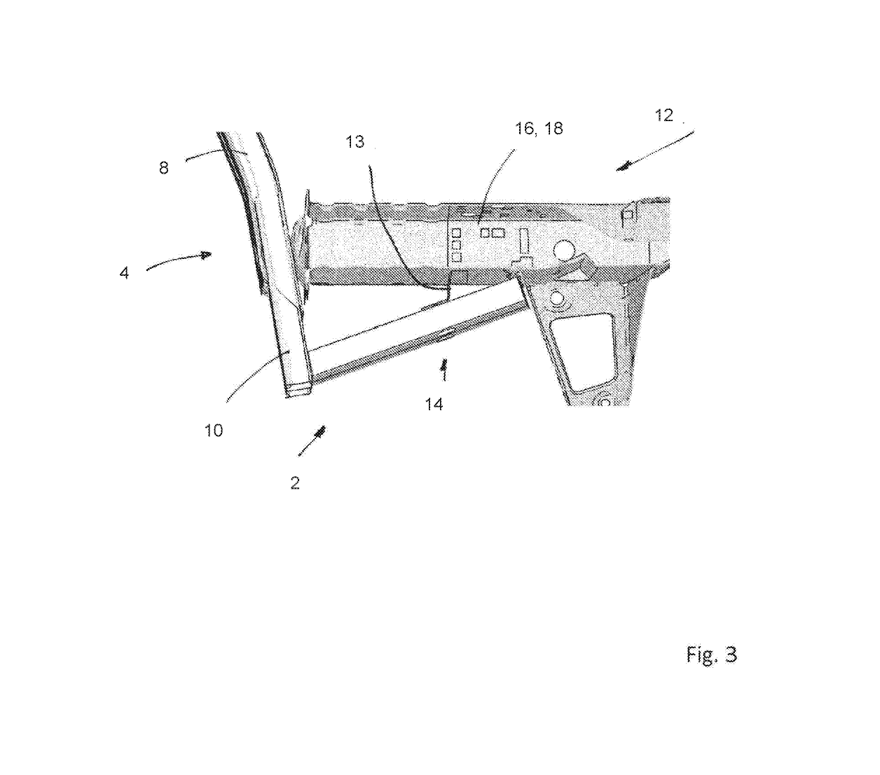

FIG. 3 shows a top view of the bumper device 2. The retaining bracket 13 includes a bent metal part, and exhibits a Z-shaped cross section, wherein its two flat sides are arranged extensively on the side member assembly 12 and on the support member 14. The support member 12 extensively abuts the side element 10, and is spaced apart from the side member assembly 12 at the end opposite the side element 10.

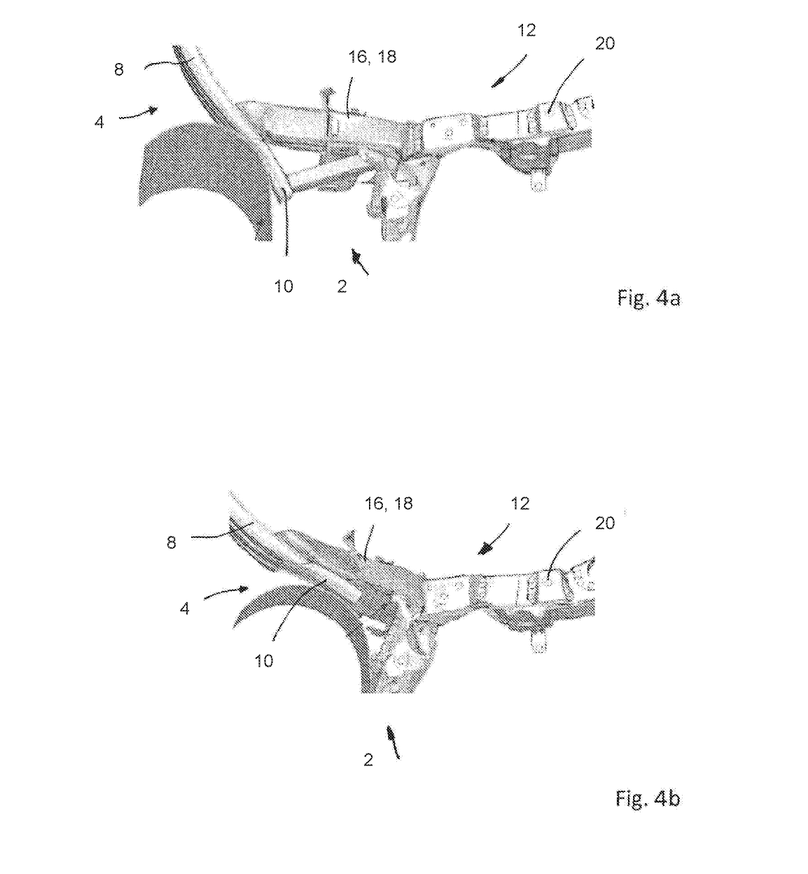

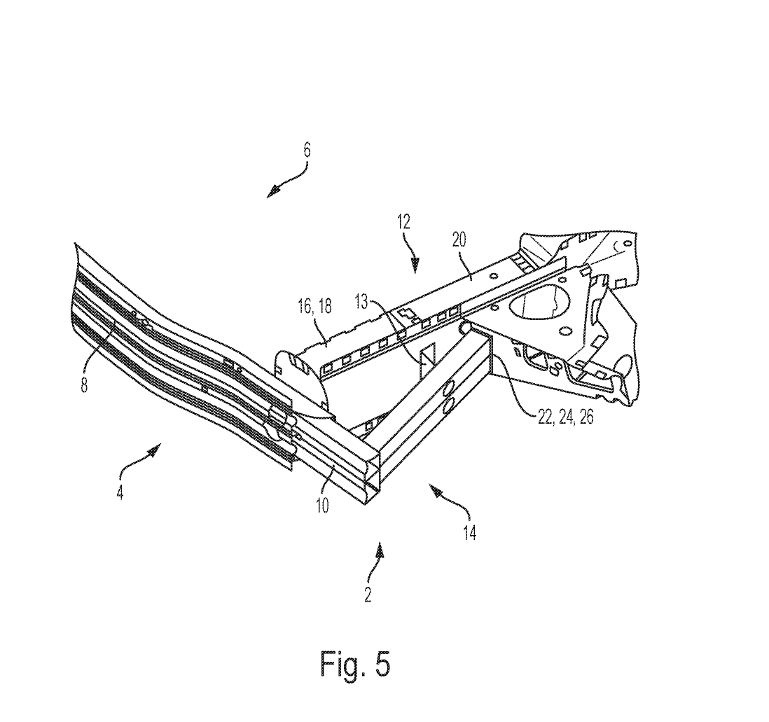

FIG. 1a and 1b show the bumper device 2, in which a specific load is acting on a side element 10. FIG. 4a shows the bumper device 2 as the load first starts to act on the side element 10 of the cross member assembly 4. FIG. 4b shows the bumper device 2, in which the load acting on the side element 10 is transferred by the support member 14 to the side member assembly 12. To this end, the support member 14 is displaced by the guide section 24 of the receptacle 22 in such a way that the support member 14 abuts against the stop 26, and transfers the load acting on the side element 10 to the side member assembly 14.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A bumper device for a motor vehicle having a body structure, the bumper device comprising:
a cross member assembly including a cross member running transverse to a traveling direction and a side element extending from an end of cross member;
a side member assembly having a first end configured to be fixed to a vehicle structure and a second end fixed to the cross member, the side member assembly including a deformation section whose extension in the traveling direction can be reduced when a longitudinal load acting on the side member assembly opposite the traveling direction has been exceeded;
a support member extending between the side member assembly and an end of the side element opposite the cross member, wherein the support member is configured to absorb and transfer an oblique load acting on the side element to the side member assembly and to deflect under the longitudinal load acting on the cross member in the traveling direction without substantial resistance; and
a receptacle extending from the side member assembly and including a guide section for guiding movement of the support member from a non-deformed position to a load-absorbing position, and a stop for limiting movement of the support member,
wherein the guide section includes a recess in the side member assembly complementing a contour of the support member.

2. The bumper device according to claim 1, wherein the support member extends from the end of the side element and is spaced apart from the side member assembly such that a non-contacting configuration is formed in a non-deformed position.

3. (canceled)

4. The bumper device according to claim 1, wherein the guide section includes a surface of the side member assembly facing the support member.

5. (canceled)

6. The bumper device according to claim 1, wherein the guide section includes a rail-like guide element fixed to the side member assembly.

7. The bumper device according to claim 1, wherein the stop includes a formed area on the side member assembly that defines a recess therein.

8. The bumper device according to claim 1, wherein the stop includes a hook-shaped stop element fixed to the side member assembly.

9. The bumper device according to claim 1, further comprising a retaining bracket fixed between the side member assembly and to the support member to bridge a gap defined between the side member assembly and support member.

10. The bumper device according to claim 9, wherein the retaining bracket comprise a bent metal part.

11. The bumper device according to claim 10, wherein the bent metal part has a Z-shaped cross section.

12. The bumper device according to claim 1, wherein the deformation section includes a crush zone having at least one crush initiator formed therein.

13. The bumper device according to claim 1, wherein the support member is configured to deform obliquely to its direction of extension.

14. The bumper device according to claim 13, wherein the support member includes a section that is reducible in terms of the extension and which includes a locally weakened area.

15. The bumper device according to claim 1, wherein the support member provides a predetermined breaking point for severing the connection between the side element and side member assembly.

16. The bumper device according to claims 1, wherein the side element extends obliquely to the traveling direction.

17. The bumper device according to claim 1, wherein the cross member and side element include components that are separable from each other.

18. The bumper device according to claim 1, wherein the cross member assembly further comprises two side elements, wherein a respective side element is situated at a respective end of the cross member that is arranged transverse to the traveling direction.
